(19) United States
(12) Patent Application Publication
(10) Pub. No.: US 2021/0210013 A1
(43) Pub. Date: Jul. 8, 2021

(54) PIXEL CIRCUIT AND DRIVING METHOD, DISPLAY PANEL, DISPLAY DEVICE

(71) Applicant: BOE TECHNOLOGY GROUP CO., LTD., Beijing (CN)

(72) Inventors: Yi Cheng LIN, Beijing (CN); Pan XU, Beijing (CN); Baoxia ZHANG, Beijing (CN); Quanhu LI, Beijing (CN); Ling WANG, Beijing (CN); Cuili GAI, Beijing (CN)

(73) Assignee: BOE TECHNOLOGY GROUP CO., LTD., Beijing (CN)

(21) Appl. No.: 16/078,840

(22) PCT Filed: Feb. 23, 2018
(86) PCT No.: PCT/CN2018/077011

§ 371 Date: Aug. 22, 2018

(30) Foreign Application Priority Data
Jul. 27, 2017 (CN) 201710624591.3

(51) Int. Cl. G09G 3/3233

(52) U.S. Cl. CPC G09G 3/3233; G09G 2320/0223; G09G 2300/043

(57) ABSTRACT

A pixel circuit and a driving method, a display panel and a display device are provided. The pixel circuit includes a data writing circuit, a compensation control circuit, a storage circuit, a light-emitting control circuit, and a drive circuit. The current output by the drive circuit in the pixel circuit of the present disclosure is only related to the data voltage of the data signal terminal and the reference voltage, and is independent of the threshold voltage of the drive circuit and the voltage of the second power terminal.

The present application claims priority to the Chinese patent application No. 201710624591.3, filed on Jul. 27, 2017, the entire disclosure of which is incorporated herein by reference as part of the present application.

### TECHNICAL FIELD

Embodiments of the present disclosure relate to a pixel circuit and a driving method, a display panel, a display device.

### BACKGROUND

Organic light emitting diode (OLED) displays involve one of the hotspots in the research field of flat panel displays, and compared with liquid crystal displays (LCDs), OLED displays have the advantages such as low energy consumption, low production cost, self-luminescence, wide viewing angle, fast response speed, and so on. Unlike an LCD, which uses a stable voltage to control brightness, an OLED is driven by a current and need a stable current to control itself to emit light. Due to manufacturing processes, the aging of a device, etc., the threshold voltage Vth of a driving transistor in a pixel circuit may become not uniform, which causes the fluctuation of the current flowing through each OLED and uneven display brightness, thereby affecting the display effect of an entire image. Moreover, because the current of each OLED is related to the source voltage of the driving transistor, that is, the power voltage, due to the voltage drop (IR Drop), the difference of current flowing through different regions may also be caused, thereby causing the uneven brightness of the OLED in the different regions.

### SUMMARY

At least one embodiment of the present disclosure provides a pixel circuit, which comprises a data writing circuit, a compensation control circuit, a storage circuit, a light-emitting control circuit and a drive circuit. The data writing circuit is respectively connected to a first control signal terminal, a data signal terminal and a first node, and the data writing circuit is configured to provide a signal of the data signal terminal to the first node under control of the first control signal terminal; the storage circuit is respectively connected to the first node, a control terminal of the drive circuit, and a second terminal of the drive circuit, and the storage circuit is configured to maintain a voltage difference between the first node and the control terminal of the drive circuit, and maintain a voltage difference between the first node and the second terminal of the drive circuit; the compensation control circuit is respectively connected to a second control signal terminal, the control terminal of the drive circuit, and a first terminal of the drive circuit, and the compensation control circuit is configured to enable the control terminal of the drive circuit to be electrically connected to the first terminal of the drive circuit under control of the second control signal terminal; the light-emitting control circuit is respectively connected to a light-emitting control signal terminal, a first power terminal, and the first terminal of the drive circuit, and the light-emitting control circuit is configured to provide a signal of the first power terminal to the drive circuit under control of the light-emitting control signal terminal; and the drive circuit is respectively connected to the compensation control circuit, the light-emitting control circuit and the storage circuit, and the drive circuit is configured to output a driving current.

For example, in the pixel circuit provided by an embodiment of the present disclosure, the storage circuit comprises a first storage circuit and a second storage circuit, and the first storage circuit is respectively connected to the first node and the control terminal of the drive circuit, and the first storage circuit is configured to maintain the voltage difference between the first node and the control terminal of the drive circuit; and the second storage circuit is respectively connected to the first node and the second terminal of the drive circuit, and the second storage circuit is configured to maintain the voltage difference between the first node and the second terminal of the drive circuit.

For example, the pixel circuit provided by an embodiment of the present disclosure further comprises a light-emitting element. A first electrode of the light-emitting element is connected to the second terminal of the drive circuit and the storage circuit, and a second electrode of the light-emitting element is connected to a second power terminal, and the light-emitting element is configured to emit light under control of the driving current output from the drive circuit.

For example, in the pixel circuit provided by an embodiment of the present disclosure, the drive circuit comprises a driving transistor, and a gate electrode of the driving transistor, as the control terminal of the drive circuit, is connected to the storage circuit and the compensation control circuit, and a first electrode of the driving transistor, as the first terminal of the drive circuit, is connected to the compensation control circuit and the light-emitting control circuit, and a second electrode of the driving transistor, as the second terminal of the drive circuit, is connected to the storage circuit.

For example, in the pixel circuit provided by an embodiment of the present disclosure, the first storage circuit comprises a first capacitor, and a first terminal of the first capacitor is connected to the first node, and a second terminal of the first capacitor is connected to the control terminal of the drive circuit.

For example, in the pixel circuit provided by an embodiment of the present disclosure, the second storage circuit comprises a second capacitor, and a first terminal of the second capacitor is connected to the first node, and a second terminal of the second capacitor is connected to the second terminal of the drive circuit.

For example, in the pixel circuit provided by an embodiment of the present disclosure, a capacitance value of the first capacitor is greater than a capacitance value of the second capacitor.

For example, in the pixel circuit provided by an embodiment of the present disclosure, the data writing circuit comprises a first switching transistor, and a gate electrode of the first switching transistor is connected to the first control signal terminal, a first electrode of the first switching transistor is connected to the data signal terminal, and a second electrode of the first switching transistor is connected to the first node.

For example, in the pixel circuit provided by an embodiment of the present disclosure, the compensation control circuit comprises a second switching transistor, and a gate electrode of the second switching transistor is connected to the second control signal terminal, a first electrode of the second switching transistor is connected to the control terminal of the drive circuit, and a second electrode of the second switching transistor is connected to the first terminal of the drive circuit.

For example, in the pixel circuit provided by an embodiment of the present disclosure, the light-emitting control circuit comprises a third switching transistor, and a gate electrode of the third switching transistor is connected to the light-emitting control signal terminal, a first electrode of the third switching transistor is connected to the first power terminal, and a second electrode of the third switching transistor is connected to the first terminal of the drive circuit.

For example, in the pixel circuit provided by an embodiment of the present disclosure, the driving transistors are N-type transistors.

For example, in the pixel circuit provided by an embodiment of the present disclosure, the switching transistors are P-type transistors or N-type transistors.

At least one embodiment of the present disclosure also provides a display panel, which comprises a plurality of pixel units arranged in an array, and each of the pixel units comprises any of the pixel circuits as provided by embodiments of the present disclosure.

At least one embodiment of the present disclosure also provides a display device, which comprises the display panel as provided by embodiments of the present disclosure.

For example, the display device provided by an embodiment of the present disclosure further comprises a plurality of first control signal lines, a plurality of second control signal lines, a plurality of light-emitting control signal lines, and a plurality of data signal lines. The first control signal line in each row is connected to the first control signal terminals of pixel circuits in the row; the second control signal line in each row is connected to the second control signal terminals of pixel circuits in the row; the light-emitting control signal line in each row is connected to the light-emitting control signal terminals of pixel circuits in the row; and the data signal line in each column is connected to the data signal terminals of pixel circuits in the column.

At least one embodiment of the present disclosure also provides a driving method of the pixel circuit, which comprises: a reset and compensation phase, a data writing phase and a light-emitting phase. In the reset and compensation phase, the compensation control circuit enables the control terminal of the drive circuit to be electrically connected to the first terminal of the drive circuit under control of the second control signal terminal; in the data writing phase, the data writing circuit provides the signal of the data signal terminal to the first node under control of the first control signal terminal; and in the light-emitting phase, the storage circuit maintains the voltage difference between the first node and the control terminal of the drive circuit, and maintains the voltage difference between the first node and the second terminal of the drive circuit, and the light-emitting control circuit provides the signal of the first power terminal to the drive circuit under control of the light-emitting control signal terminal, and the drive circuit outputs the driving current.

### BRIEF DESCRIPTION OF THE DRAWINGS

In order to clearly illustrate the technical solution of the embodiments of the present disclosure, the embodiments or the drawings of the related technical description will be briefly described in the following, it is obvious that the described drawings are only related to some embodiments of the present disclosure and thus are not limitative of the present disclosure.

FIG. 1 is a schematic diagram of a pixel circuit;

FIG. 2 is a schematic diagram of a pixel circuit provided by an embodiment of the present disclosure;

FIG. 3 is a schematic diagram of another pixel circuit provided by an embodiment of the present disclosure;

FIG. 4 is a circuit diagram of a specific implementation example of a pixel circuit provided by an embodiment of the present disclosure;

FIG. 5 is a circuit timing diagram of a driving method provided by an embodiment of the present disclosure;

FIG. 6 is a simulation diagram of a pixel circuit provided by an embodiment of the present disclosure;

FIG. 7 is a schematic flowchart diagram of a driving method of a pixel circuit provided by an embodiment of the present disclosure; and

FIG. 8 is a schematic diagram of a display device provided by an embodiment of the present disclosure.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but can include an electrical connection, directly or indirectly. “On,” “under,” “right,” “left” and the like are only used to indicate relative position relationship, and when the position of the object which is described is changed, the relative position relationship can be changed accordingly.

It should be noted that transistors used in embodiments of the present disclosure may all be thin film transistors, field effect transistors, or other switching device having the like characteristics, and thin film transistors are taken as an example for description in the embodiments of the present disclosure. A source electrode and a drain electrode of a transistor used here can be symmetrical in structure, so the source electrode and the drain electrode of the transistor can be indistinguishable in structure. In the embodiments of the present disclosure, in order to distinguish the two electrodes of the transistor except the gate electrode, one of the two electrodes is directly described as a first electrode, and the other electrode is described as a second electrode. Furthermore, a switching transistor used in the embodiments of the present disclosure may comprise any one of a P-type switching transistor and an N-type switching transistor; the P-type switching transistor is turned on when the gate electrode is at a low level, and is turned off when the gate electrode is at a high level, while the N-type switching transistor is turned on when the gate electrode is at a high level, and is turned off when the gate electrode is at a low level.

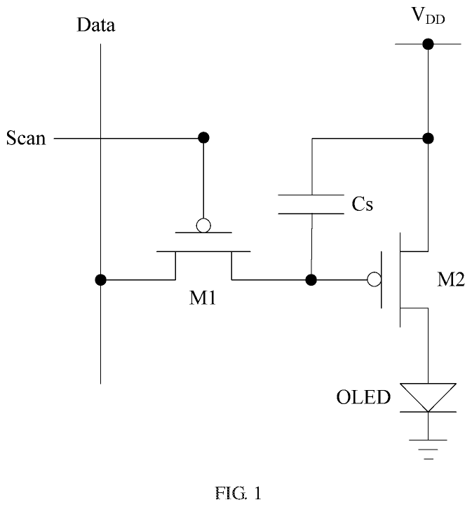

In a pixel circuit as shown in FIG. 1, the pixel circuit comprises a driving transistor M0, a switching transistor M, and a storage capacitor Cs. When a scan line Scan scans a certain row, the scan line Scan inputs a low level signal, the P-type switching transistor M is turned on, and the voltage over a data line Data is written into the storage capacitor Cs; when the scanning of the row is finished, the signal input by the scan line Scan becomes a high level, and the P-type switching transistor M is turned off, and a gate voltage stored by the storage capacitor Cs causes the driving transistor M0 to generate a current to drive the OLED, ensuring that the OLED continues to emit light within one frame. A saturation current formula of the driving transistor M0 is I_{OLED}=K(Vsg−Vth)₂, and the threshold voltage Vth of the driving transistor M0 may drift due to manufacturing process and aging of the elements, and because the current is related to the power voltage, and due to the voltage drop (IR Drop), the source voltage Vs of the driving transistor becomes different, which causes the current flowing through each of the OLEDs to vary due to the variation of the threshold voltage Vth of the driving transistor and the variation of the source voltage of the driving transistor, thereby resulting in uneven brightness of an image.

At least one embodiment of the present disclosure provides a pixel circuit comprising a data writing circuit, a compensation control circuit, a first storage circuit, a second storage circuit, a light-emitting control circuit, and a drive circuit. At least one embodiment of the present disclosure also provides a driving method, a display panel, and a display device corresponding to the pixel circuit.

The pixel circuit, the display panel, the display device, and the driving method provided by the embodiments of the present disclosure can enable the current output by the driving circuit of the pixel circuit to be only related to a data voltage of a data signal terminal and a reference voltage, and is independent of a threshold voltage of the drive circuit, so the influence of the threshold voltage of the drive circuit on the current output by the drive circuit can be avoided, the current output by the drive circuit can be kept stable, and the uniformity of the brightness of the display screen of the display device comprising the pixel circuit can be improved.

The embodiments of the present disclosure will be described in detail below with reference to the accompanying drawings.

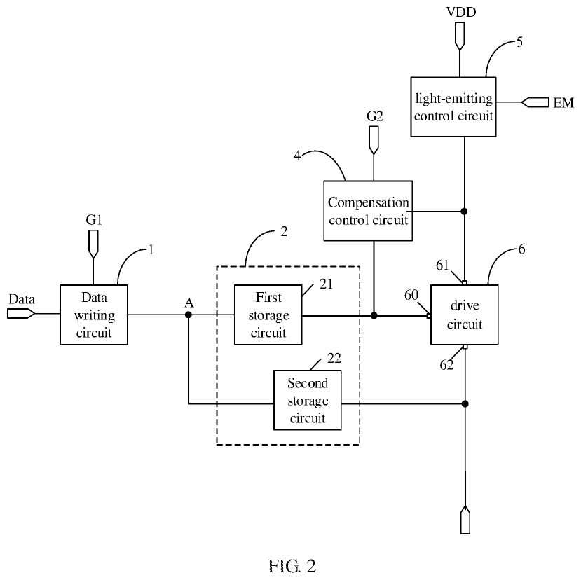

At least one embodiment of the present disclosure provides a pixel circuit, as shown in FIG. 2, the pixel circuit comprises a data writing circuit 1, a storage circuit 2, a compensation control circuit 4, a light-emitting control circuit 5, and a drive circuit 6.

The data writing circuit 1 is respectively connected to a first control signal terminal G1, a data signal terminal Data and a first node A; the data writing circuit 1 is configured to provide a signal from the data signal terminal Data to the first node A under the control of the first control signal terminal G1. For example, the signal of the data signal terminal Data is a data voltage that controls the degree of brightness of the pixel.

The storage circuit 2 is respectively connected to the first node A, a control terminal 60 of the drive circuit 6, and a second terminal 62 of the drive circuit 6. The storage circuit 2 is configured to maintain a voltage difference between the first node A and the control terminal 60 of the drive circuit 6, and maintain a voltage difference between the first node A and the second terminal 62 of the drive circuit 6.

The compensation control circuit 4 is respectively connected to a second control signal terminal 62, the control terminal 60 of the drive circuit 6, and a first terminal 61 of the drive circuit 6, and the compensation control circuit 4 is configured to enable the control terminal 60 of the drive circuit 6 to be electrically connected to the first terminal 61 of the drive circuit 6 under control of the second control signal terminal G2.

The light-emitting control circuit 5 is respectively connected to a light-emitting control signal terminal EM, a first power terminal VDD, and the first terminal 61 of the drive circuit 6, and the light-emitting control circuit 5 is configured to provide a signal of the first power terminal VDD to the drive circuit 6 under control of the light-emitting control signal terminal EM.

The drive circuit 6 is respectively connected to the compensation control circuit 4, the light-emitting control circuit 5 and the storage circuit 2, and the drive circuit 6 is configured to output a driving current. For example, the drive circuit 6 outputs the driving current from the second terminal 62. For example, the driving current can be used to drive the light-emitting element to emit light.

The pixel circuit provided by the embodiment of the present disclosure comprises a data writing circuit, a compensation control circuit, a storage circuit, a light-emitting control circuit, and a drive circuit. The data writing circuit is configured to provide the signal of the data signal terminal to the first node under the control of the first control signal terminal; the storage circuit is configured to maintain a voltage difference between the first node and the control terminal of the drive circuit, and maintain a voltage difference between the first node and the second terminal of the drive circuit; the compensation control circuit is configured to enable the control terminal of the drive circuit to be electrically connected to the first terminal of the drive circuit under the control of the second control signal terminal; the light-emitting control circuit is configured to provide a signal of the first power terminal to the drive circuit under control of the light-emitting control signal terminal; the drive circuit is configured to output a driving current. Therefore, the mutual cooperation of the above five circuits can render the current output by the drive circuit of the pixel circuit to be only related to the data voltage of the data signal terminal and the reference voltage, and is independent of the threshold voltage of the drive circuit, so the influence of the threshold voltage of the drive circuit on the current output by the drive circuit can be avoided, the current output by the drive circuit can be kept stable, and the uniformity of the brightness of the display screen of the display device comprising the pixel circuit can be improved.

For example, in one embodiment of the present disclosure, as shown in FIG. 2, the storage circuit 2 may comprise a first storage circuit 21 and a second storage circuit 22.

The first storage circuit 21 is respectively connected to the first node A and the control terminal 60 of the drive circuit 6, and the first storage circuit 21 is configured to maintain the voltage difference between the first node A and the control terminal 60 of the drive circuit 6.

The second storage circuit 22 is respectively connected to the first node A and the second terminal 62 of the drive circuit 6, and the second storage circuit 22 is configured to maintain the voltage difference between the first node A and the second terminal 62 of the drive circuit 6.

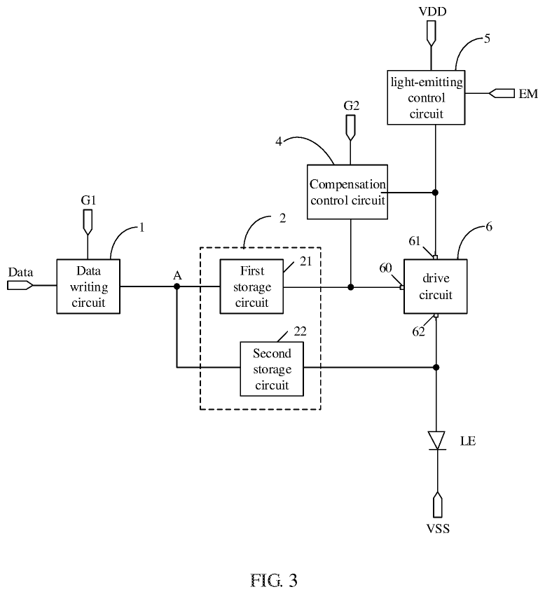

For example, in one embodiment of the present disclosure, as shown in FIG. 3, the pixel circuit may further comprise a light-emitting element LE. A first electrode of the light-emitting element LE is connected to the second terminal 62 of the drive circuit 6 and the second storage circuit 22, and a second electrode of the light-emitting element LE is connected to a second power terminal VSS. The light-emitting element is used to emit light under control of the driving current output from the drive circuit 6. For example, the light-emitting element LE emits light under the control of the current when the drive circuit is in a saturated state.

For example, the light-emitting element LE may be an organic light-emitting diode (OLED). The embodiments of the present disclosure include, but are not limited to, this case, and the following embodiments are described by using an OLED as an example, and details are not described here. For example, in a case where the light-emitting element LE is an OLED, an anode of the OLED may be connected to the second terminal 62 of the drive circuit 6, and a cathode of the OLED may be connected to the second power terminal VSS. It should be noted that the OLED may be of various types, such as a top emission, a bottom emission, or the like, and may emit red light, green light, blue light, or white light, etc., which is not limited in the embodiment of the present disclosure. In addition, the OLED also has a threshold voltage, and emits light when the voltage across the OLED is greater than or equal to the threshold voltage.

It should be noted that, in the pixel circuit provided by the embodiment of the present disclosure, the voltage of the first power terminal VDD is a high level voltage, and the voltage of the second power terminal VSS is grounded or a low level voltage, and the following embodiments are the same as those described herein and will not be described again.

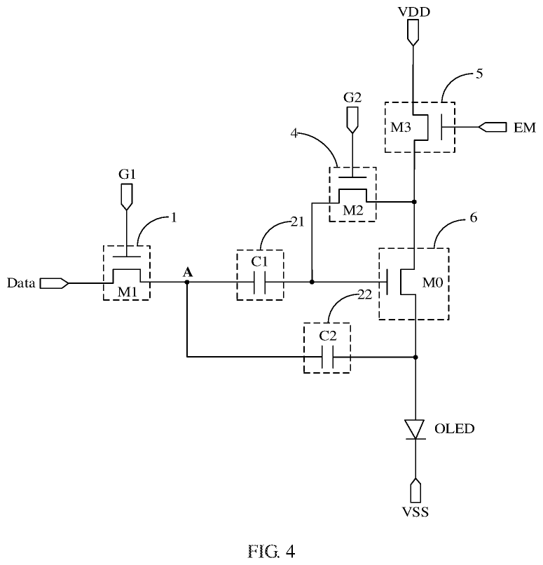

For example, the pixel circuit as shown in FIG. 3 can be specifically implemented as the pixel circuit structure as shown in FIG. 4. As shown in FIG. 4, the pixel circuit comprises a driving transistor M0, a first switching transistor M1, a second switching transistor M2, a third switching transistor M3, a first capacitor C1, a second capacitor C2, and a light-emitting element OLED. The transistors in the pixel circuit are all described by taking N-type transistors as an example.

For example, as shown in FIG. 4, in more detail, the drive circuit 6 can be implemented as the driving transistor M0. A gate electrode of the driving transistor M0, as the control terminal 60 of the drive circuit 6, is connected to the first storage circuit 21 and the compensation control circuit 4, and a first electrode of the driving transistor M0, as the first terminal 61 of the drive circuit 6, is connected to the compensation control circuit 4 and the light-emitting control circuit 5, and a second electrode of the driving transistor M0, as the second terminal 62 of the drive circuit 6, is connected to the second storage circuit 22.

The first storage circuit 21 can be implemented as a first capacitor C1. A first terminal of the first capacitor C1 is connected to the first node A, and a second terminal of the first capacitor C1 is connected to the control terminal of the drive circuit 6. For example, when the drive circuit 6 is implemented as the driving transistor M0, the second terminal of the first capacitor C1 may be connected to the gate electrode of the driving transistor M0.

In the pixel circuit provided by the embodiment of the present disclosure, the first capacitor C1 is charged under the common control of both the signal of the first node A and the signal of the gate electrode of the driving transistor M0, and is discharged under the common control of both the signal of the first node A and the signal of the gate electrode of the driving transistor M0; and when the gate electrode of the driving transistor M0 is in a floating state, the first capacitor C1 maintains the voltage difference between the first node A and the gate electrode of the driving transistor M0 stable, so as to store the threshold voltage Vth of the driving transistor M0 and the data voltage input to the data signal terminal Data at the gate electrode of the driving transistor M0.

The above description is only an example of the specific structure of the first storage circuit 21 in the pixel circuit. In the specific implementation, the specific structure of the first storage circuit 21 is not limited to the above structure provided by the embodiment of the present disclosure, and may be other structures known to those skilled in the art, which are not limited in this aspect here.

For example, as shown in FIG. 4, the second storage circuit 22 can be implemented as a second capacitor C2. A first terminal of the second capacitor C2 is connected to the first node A, and a second terminal of the second capacitor C2 is connected to the second terminal of the drive circuit 6. For example, when the drive circuit 6 is implemented as the driving transistor M0, the second terminal of the second capacitor C2 may be connected to the second electrode of the driving transistor M0. For example, the second terminal of the second capacitor C2 can also be connected to the anode of the light-emitting element OLED.

In the pixel circuit provided by the embodiment of the present disclosure, the second capacitor C2 is charged under the common control of both the signal of the first node A and the signal of the second electrode of the driving transistor M0, and is discharged under the common control of both the signal of the first node A and the signal of the second electrode of the driving transistor M0; and when the light emitting element OLED is in a light-emitting state, the second capacitor C2 maintains the voltage difference between the first node A and the second electrode of the driving transistor M0 stable, so as to ensure that the driving transistor M0 outputs a stable driving current.

The above description is only an example of the specific structure of the second storage circuit 22 in the pixel circuit. When it is specifically implemented, the specific structure of the second storage circuit 22 is not limited to the above-mentioned structure provided by the embodiment of the present disclosure, and may be other structures known to those skilled in the art, which are not limited in this aspect here.

In the pixel circuit provided by the embodiment of the present disclosure, because the first capacitor C1 keeps the voltage difference between the gate electrode of the driving transistor M0 and the first node A stable for a long time to ensure the current flowing to the light-emitting element OLED to be constant, the capacitance value of the first capacitor C1 is relatively greater. In order to reduce the area that is occupied, the capacitance value of the second capacitor C2 is relatively smaller. Therefore, in the pixel circuit provided by one embodiment of the present disclosure, the capacitance value of the first capacitor C1 may be greater than the capacitance value of the second capacitor C2.

For example, as shown in FIG. 4, the data writing circuit 1 can be implemented as the first switching transistor M1. A gate electrode of the first switching transistor M1 is connected to the first control signal terminal G1, a first electrode of the first switching transistor M1 is connected to the data signal terminal Data, and a second electrode of the first switching transistor M1 is connected to the first node A.

In the pixel circuit provided by the embodiment of the present disclosure, for example, when the first switching transistor M1 is in an turn-on state under the control of the first control signal terminal G1, the signal from the data signal terminal Data can be supplied to the first node A.

The above description is only an example of the specific structure of the data writing circuit 1 in the pixel circuit. When it is specifically implemented, the specific structure of the data writing circuit 1 is not limited to the above-mentioned structure provided by the embodiment of the present disclosure, and may be other structures known to those skilled in the art, which are not limited in this aspect here.

For example, as shown in FIG. 4, the compensation control circuit 4 can be implemented as a second switching transistor M2. A gate electrode of the second switching transistor M2 is connected to the second control signal terminal G2, a first electrode of the second switching transistor M2 is connected to the control terminal of the drive circuit 6, and a second electrode of the second switching transistor M2 is connected to the first terminal of the drive circuit 6. For example, when the driving circuit 6 is implemented as the driving transistor M0, the first electrode of the second switching transistor M2 may be connected to the gate electrode of the driving transistor M0, and the second electrode of the second switching transistor M2 may be connected to the first electrode of the driving transistor M0.

In the pixel circuit provided by the embodiment of the present disclosure, for example, the second switching transistor M2 can enable the gate electrode of the driving transistor M0 to be electrically connected to the first electrode of the driving transistor M0 under the control of the second control signal terminal G2, so as to control the driving transistor M0 to be in a diode-connection state.

The above description is only an example of the specific structure of the compensation control circuit 4 in the pixel circuit. When it is specifically implemented, the specific structure of the compensation control circuit 4 is not limited to the above-mentioned structure provided by the embodiments of the present disclosure, and may be other structures known to those skilled in the art, which are not limited in this aspect here.

For example, as shown in FIG. 4, the light-emitting control circuit 5 can be implemented as a third switching transistor M3. A gate electrode of the third switching transistor M3 is connected to the light-emitting control signal terminal EM, a first electrode of the third switching transistor M3 is connected to the first power terminal VDD, and a second electrode of the third switching transistor M3 is connected to the first terminal of the drive circuit. For example, when the drive circuit 6 is implemented as the driving transistor M0, the second electrode of the third switching transistor M3 may be connected to the first electrode of the driving transistor M0.

In the pixel circuit provided by the embodiment of the present disclosure, for example, the third switching transistor M3 can supply the voltage of the first power terminal VDD to the first electrode of the driving transistor M0 under the control of the light-emitting control signal terminal EM, and can output a driving current output from the second electrode of the driving transistor M0 to, for example, the light-emitting element OLED to drive the light-emitting element to emit light.

The above description is only an example of the specific structure of the light-emitting control circuit 5 in the pixel circuit. When it is specifically implemented, the specific structure of the light-emitting control circuit 5 is not limited to the above-mentioned structure provided by the embodiments of the present disclosure, and may be other structures known to those skilled in the art, which are not limited in this aspect here.

For example, in the pixel circuit provided by the embodiment of the present disclosure, the driving transistor M0 is an N-type transistor. It should be noted that, in the pixel circuit provided by the embodiment of the present disclosure, the first switching transistor M1, the second switching transistor M2, and the third switching transistor M3 may all use P-type transistors, or may be P-type transistors and N-type transistors in combination in addition to the N-type transistors as shown in FIG. 4, and as long as the polarities of the terminals of transistors of the selected types are correspondingly connected according to the polarities of the terminals of the corresponding transistors in the embodiment of the present disclosure.

Preferably, in specific practice, in the pixel circuit provided by the embodiment of the present disclosure, as shown in FIG. 4, the driving transistor M0 and all of the switching transistors M1-M3 are N-type transistors.

When it is specifically implemented, in the pixel circuit provided by the embodiment of the present disclosure, the N-type switching transistor is turned on under the control of a high potential and turned off under the control of a low potential.

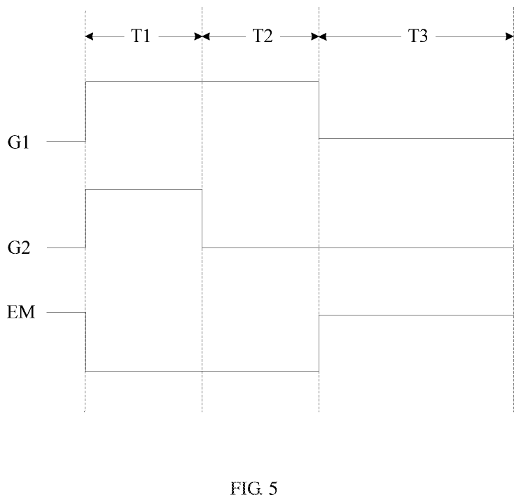

The operation principle of the pixel circuit provided by the embodiment of the present disclosure will be described with reference to the circuit timing diagram shown in FIG. 5 by taking the pixel circuit shown in FIG. 4 as an example in the following. It should be noted that, in the following description, a high potential is represented by 1, and a low potential is represented by 0. The digits 1 and 0 are logic potentials, which are only used for better explanation of the operation principle of the pixel circuit provided by the embodiments of the present disclosure, rather than the actual potential applied to the gate electrodes of the respective switching transistors.

As shown in FIG. 4, the driving transistor M0 is an N-type transistor, and all of the switching transistors are N-type transistors, and the corresponding timing diagram is as shown in FIG. 5. Specifically, the three stages, that is, a reset and compensation phase T1, a data writing phase T2, and a light-emitting phase T3, in the timing diagram as shown in FIG. 5 are selected for description.

In the reset and compensation phase T1, G1=1, G2=1, and EM=0.

The first switching transistor M1, the second switching transistor M2, and the driving transistor M0 are all in a turn-on state, and the third switching transistor M3 is in a turn-off state. The voltage of the data signal terminal Data at this stage is the reference voltage Vref, so the turned-on first switching transistor M1 supplies the reference voltage Vref of the data signal terminal Data to the first node A, and therefore the voltage V_{A} of the first node A is V_{A}=Vref, that is, the reset of the voltage of the first node A is realized. The turned-on second switching transistor M2 can electrically connect the gate electrode of the driving transistor M0 with the first electrode of the driving transistor M0, so the driving transistor M0 is in a diode-connection state, and therefore the voltage of the gate electrode and the voltage of the source electrode of the driving transistor M0 are released by the light-emitting element OLED, that is, the reset of the pixel circuit is realized. The voltage of the anode of the light-emitting element OLED, that is, the voltage Vs of the source electrode of the driving transistor M0 is the sum of the voltage V_{SS} of the second power terminal VSS and the threshold voltage Voled0 of the light-emitting element OLED, that is, Vs=VSS+Voled0. Because the driving transistor M0 is in the diode-connection state at this stage, the voltage Vg of the gate electrode of the driving transistor M0 is the voltage of the source electrode of the driving transistor M0 plus the threshold voltage Vth of the driving transistor M0, that is, Vg=V_{SS}+Voled0+Vth, thereby the threshold voltage Vth of the driving transistor M0 can be written to the gate electrode of the driving transistor M0.

In the data writing phase T2, G1=1, G2=0, and EM=0. The first switching transistor M1 and the driving transistor M0 are both in a turn-on state, and the second switching transistor M2 and the third switching transistor M3 are both in a turn-off state. For example, at this stage, the voltage written by the data signal terminal Data is Vdata, that is, the voltage Vdata of the data signal terminal Data is supplied to the first node A by the turned-on first switching transistor M1, and therefore, the voltage VA of the first node A is changed from Vref in the previous stage to Vdata. Due to the coupling action of the first capacitor C1, the voltage Vg of the gate electrode of the driving transistor M0 becomes Vg=V_{SS}+Voled0+Vth+Vdata−Vref.

In the light-emitting phase T3, G1=0, G2=0, and EM=1. The third switching transistor M3 and the driving transistor M0 are both in a turn-on state, and the first switching transistor M1 and the second switching transistor M2 are both in a turn-off state. The light-emitting element OLED starts to emit light, and the voltage of the anode of the light-emitting element OLED is V_{SS}+Voled, that is, the voltage of the source electrode of the driving transistor M0 is Vs=V_{SS}+Voled, and Voled is the voltage when the light-emitting element OLED emits light. In this stage, due to the coupling action of the second capacitor C2, the change of the voltage of the second terminal of the second capacitor C2 is coupled to the first terminal of the second capacitor C2, that is, the first node A, so the voltage of the first node A becomes VA=Vdata+Voled−Voled0. At the same time, due to the coupling action of the first capacitor C1, the voltage of the gate electrode of the driving transistor M0 becomes Vg=V_{SS}+Voled0+Vth+Vdata−Vref+Voled−Voled0=V_{SS}+Voled+Vth+Vdata−Vref. The voltage of the first electrode of the driving transistor M0 is the voltage V_{DD} of the first power terminal VDD, and the driving transistor M0 is in a saturated state. According to the current characteristic in a saturation state, the operating current I_{OLED} flowing through the driving transistor M0 and used to drive the light-emitting element OLED to emit light satisfies the following formula:

$$\begin{matrix}{I}_{OLED} = {K ( Vgs - Vth )}^{2} \\ = {K ( {V}_{SS} + Voled + Vth + Vdata - Vref - {V}_{SS} - Voled - Vth )}^{2} \\ = {K ( Vdata - Vref )}^{2} ,\end{matrix}$$

where K is a structural parameter, and this value is relatively stable in the same structure and can be counted as a constant. It can be seen that the operating current I_{OLED} of the light-emitting element OLED can be unaffected by the threshold voltage Vth of the driving transistor M0, and is independent of the voltage V_{SS} of the second power terminal VSS, and is only related to the data voltage Vdata of the data signal terminal Data and the reference voltage Vref, which avoids the influence of the threshold voltage Vth drift of the driving transistor M0 and the voltage drop (IR Drop) on the operating current I_{OLED} of the light-emitting element OLED due to manufacturing process and long-time operation. Also, the current I_{OLED} is also independent of the threshold voltage Voled0 and the operating voltage Voled of the light-emitting element OLED, and the difference in current due to the aging of the OLED can be avoided, thereby improving the display unevenness of the panel. Moreover, the pixel circuit provided by the embodiment of the present disclosure can compensate the threshold voltage Vth of the driving transistor M0 by using only four transistors and two capacitors, and the structure is relatively simple.

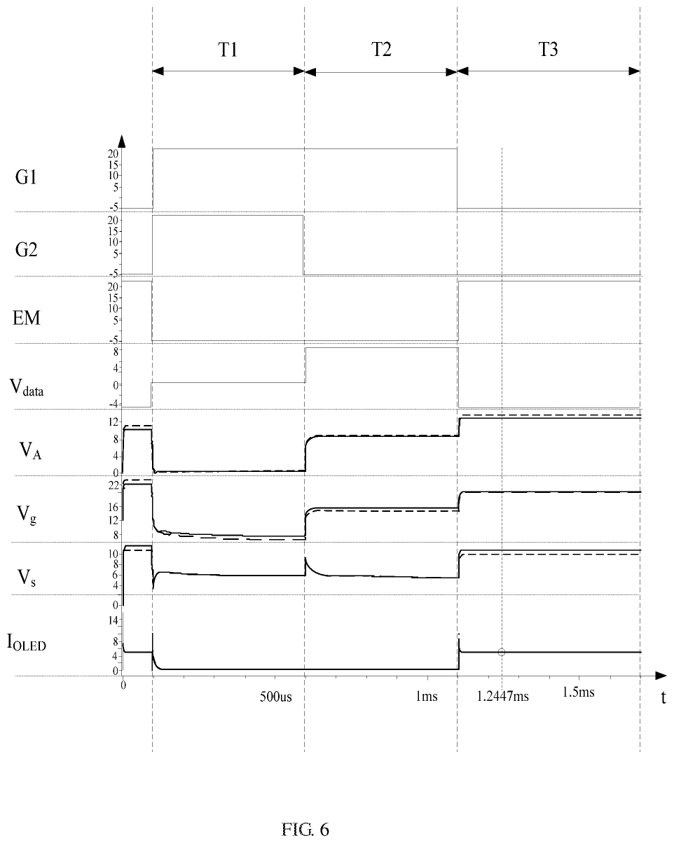

Moreover, when the threshold voltage Vth of the driving transistor M0 takes different values, the present disclosure also performs simulation on the pixel circuit provided by the above embodiment in three stages, and the simulation results are shown in FIG. 6. When the threshold voltages Vth of the driving transistor M0 are Vth=1 and Vth=2, respectively, it can be seen from the simulation result of FIG. 6 that the driving currents flowing through the light-emitting elements OLED are substantially coincident, and the operation current I_{OLED} flowing through the light-emitting element OLED at any time in the T3 phase, such as 1.2447 ms, is taken, and when the threshold voltage Vth of the driving transistor M0 is equal to 1, I_{OLED1}=4.842 uA; when the threshold voltage Vth of the driving transistor M0 is equal to 2, I_{OLED2}=4.8416 uA; the current I_{OLED1} and the current I_{OLED2} are approximately equal, so it can be verified that the operation current I_{OLED} of the light-emitting element OLED can be unaffected by the threshold voltage Vth of the driving transistor M0 in the pixel circuit provided by the embodiment of the present disclosure.

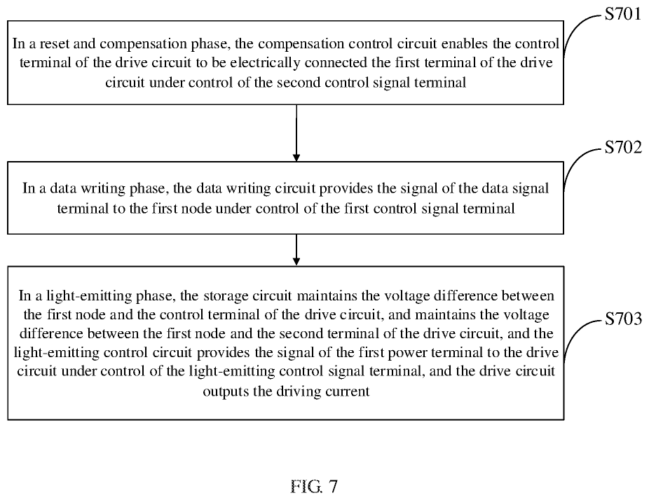

The embodiment of the present disclosure further provides a driving method, which can be used for any of the pixel circuits provided by the embodiments of the present disclosure. For example, as shown in FIG. 7, the driving method comprises the following operational steps.

Step S701: in the reset and compensation phase, the compensation control circuit enables the control terminal of the drive circuit to be electrically connected to the first terminal of the drive circuit under control of the second control signal terminal.

Step S702: in the data writing phase, the data writing circuit provides the signal of the data signal terminal to the first node under control of the first control signal terminal.

Step S703: in the light-emitting phase, the storage circuit maintains the voltage difference between the first node and the control terminal of the drive circuit, and maintains the voltage difference between the first node and the second terminal of the drive circuit, and the light-emitting control circuit provides the signal of the first power terminal to the drive circuit under control of the light-emitting control signal terminal, and the drive circuit outputs the driving current.

It should be noted that the detailed description of the driving method of the pixel circuit provided by the embodiment of the present disclosure can be referred to a corresponding description about the working principle of the pixel circuit, and details are not described herein again.

The driving method of the pixel circuit provided by an embodiment of the present disclosure, can cause that the operation current driving the light-emitting element to emit light by the driving transistor in the pixel circuit is only related to the data voltage of the data signal terminal and the reference voltage, and is independent of the threshold voltage of the driving transistor and the voltage of the second power terminal, so the influence of the threshold voltage of the driving transistor and the voltage drop on the current output by the driving transistor can be avoided, thereby the current output by the driving transistor is kept stable, and the uniformity of the brightness of the display screen of the display device comprising the pixel circuit can be improved.

A display panel is also provided by embodiments of the present disclosure, which comprises a plurality of pixel units arranged in an array, and each of the pixel units comprises any of the pixel circuits as provided by embodiments of the present disclosure. The operation principle of the display panel solving the problem is similar to the foregoing pixel circuit, so the implementation of the display panel can be referred to the implementation of the pixel circuit described above, and the repeated description is omitted.

When it is specifically implemented, in the display panel provided by the embodiment of the present disclosure, the display panel may be an organic electroluminescence display panel.

Embodiments of the present disclosure also provide a display device, and the display device comprises a display panel provided by the embodiment of the present disclosure.

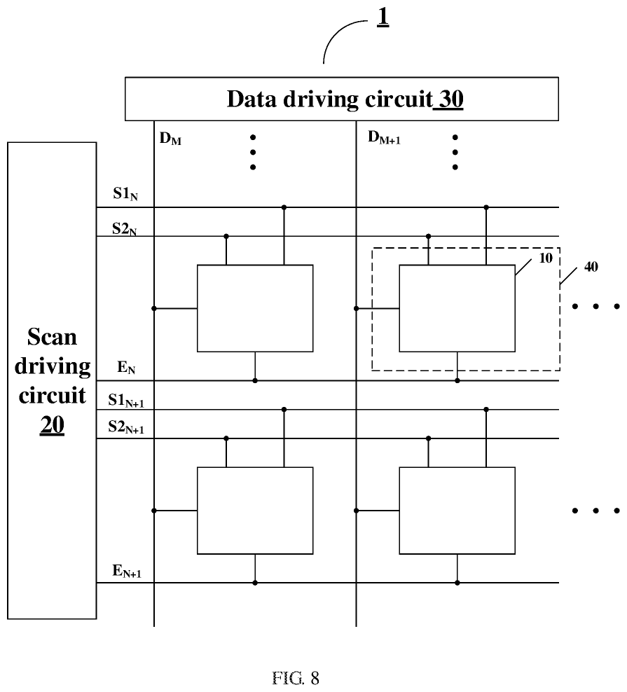

For example, as shown in FIG. 8, the display device 1 comprises a plurality of pixel units 40 arranged in an array, a plurality of first control signal lines, a plurality of second control signal lines, a plurality of light-emitting control signal lines, and a plurality of data signal lines. It should be noted that only a part of the pixel units 40, a part of the first control signal lines, a part of the second control signal lines, a part of the light-emitting control signal lines, and a part of the data signal lines are shown in FIG. 8. For example, S1_{N} represents the first control signal line of the Nth row, and S1_{N+1} represents the first control signal line of the (N+1)th row, and S2_{N} represents the second control signal line of the Nth row, and S2_{N+1} represents the second control signal line of the (N+1)th row, and E_{N} represents the light-emitting control signal line of the Nth row, and E_{N+1} represents the light-emitting control signal line of the (N+1)th row, and D_{M} represents the data signal line of the Mth column, and D_{M+1} represents the data signal line of the (M+1)th column. Here, N and M are, for example, integers greater than zero.

For example, each of the pixel units 40 may comprise any of the pixel circuits 10 provided in the above embodiments, for example, the pixel circuits as shown in FIG. 4.

For example, the first control signal line in each row is connected to the first control signal terminals of pixel circuits in the row; the second control signal line in each row is connected to the second control signal terminals of pixel circuits in the row; the light-emitting control signal line in each row is connected to the light-emitting control signal terminals of pixel circuits in the row; and the data signal line in each column is connected to the data signal terminals of pixel circuits in the column.

It should be noted that the display device 1 as shown in FIG. 8 may further comprise a plurality of first power lines and a plurality of second power lines to respectively provide voltages V_{DD} and V_{SS} (not be shown in FIG. 8).

For example, as shown in FIG. 8, the display device 1 may further comprise a scan driving circuit 20 and a data driving circuit 30.

For example, the data driving circuit 30 may be connected to a plurality of data signal lines (D_{M}, D_{M+1}, etc.) to provide data voltages Vdata. For example, the scan driving circuit 20 may be connected to a plurality of first control signal lines (S1_{N}, S1_{N+1}, etc.), a plurality of second control signal lines (S2_{N}, S2_{N+1}, etc.), and a plurality of light-emitting control signal lines (E_{N}, E_{N+1}, etc.) to provide control signals.

For example, the scan driving circuit 20 and the data driving circuit 30 each can be implemented as a semiconductor chip. The display device 1 may also comprise other components such as a timing controller, a signal decoding circuit, a voltage conversion circuit, etc., which may be, for example, conventional components that already exist, and will not be described in detail herein.

For example, the display device 1 provided by the embodiment of the present disclosure may be any product or component having a display function, such as a mobile phone, a tablet computer, a television, a display, a notebook computer, a digital photo frame, a navigator, and the like. Other indispensable components of the display device are understood by those skilled in the art, and are not described herein, nor should they be construed as limiting the invention. The implementation of the display device can refer to the embodiment of the pixel circuit described above, and the repeated description is omitted.

What are described above is related to the illustrative embodiments of the disclosure only and not limitative to the scope of the disclosure, the scopes of the disclosure are defined by the accompanying claims.

1. A pixel circuit, comprising: a data writing circuit, a compensation control circuit, a storage circuit, a light-emitting control circuit and a drive circuit,
wherein the data writing circuit is respectively connected to a first control signal terminal, a data signal terminal and a first node, and the data writing circuit is configured to provide a signal of the data signal terminal to the first node under control of the first control signal terminal;
the storage circuit is respectively connected to the first node, a control terminal of the drive circuit, and a second terminal of the drive circuit, and the storage circuit is configured to maintain a voltage difference between the first node and the control terminal of the drive circuit, and maintain a voltage difference between the first node and the second terminal of the drive circuit;
the compensation control circuit is respectively connected to a second control signal terminal, the control terminal of the drive circuit, and a first terminal of the drive circuit, and the compensation control circuit is configured to enable the control terminal of the drive circuit to be electrically connected to the first terminal of the drive circuit under control of the second control signal terminal;
the light-emitting control circuit is respectively connected to a light-emitting control signal terminal, a first power terminal, and the first terminal of the drive circuit, and the light-emitting control circuit is configured to provide a signal of the first power terminal to the drive circuit under control of the light-emitting control signal terminal; and
the drive circuit is respectively connected to the compensation control circuit, the light-emitting control circuit and the storage circuit, and the drive circuit is configured to output a driving current.

2. The pixel circuit according to claim 1, wherein the storage circuit comprises a first storage circuit and a second storage circuit, and
the first storage circuit is respectively connected to the first node and the control terminal of the drive circuit, and the first storage circuit is configured to maintain the voltage difference between the first node and the control terminal of the drive circuit; and
the second storage circuit is respectively connected to the first node and the second terminal of the drive circuit, and the second storage circuit is configured to maintain the voltage difference between the first node and the second terminal of the drive circuit.

3. The pixel circuit according to claim 1, further comprising a light-emitting element,
wherein a first electrode of the light-emitting element is connected to the second terminal of the drive circuit and the storage circuit, and a second electrode of the light-emitting element is connected to a second power terminal, and the light-emitting element is configured to emit light under control of the driving current output from the drive circuit.

4. The pixel circuit according to claim 1, wherein the drive circuit comprises a driving transistor, and
a gate electrode of the driving transistor, as the control terminal of the drive circuit, is connected to the storage circuit and the compensation control circuit, and a first electrode of the driving transistor, as the first terminal of the drive circuit, is connected to the compensation control circuit and the light-emitting control circuit, and a second electrode of the driving transistor, as the second terminal of the drive circuit, is connected to the storage circuit.

5. The pixel circuit according to claim 2, wherein the first storage circuit comprises a first capacitor, and
a first terminal of the first capacitor is connected to the first node, and a second terminal of the first capacitor is connected to the control terminal of the drive circuit.

6. The pixel circuit according to claim 5, wherein the second storage circuit comprises a second capacitor, and
a first terminal of the second capacitor is connected to the first node, and a second terminal of the second capacitor is connected to the second terminal of the drive circuit.

7. The pixel circuit according to claim 6, wherein a capacitance value of the first capacitor is greater than a capacitance value of the second capacitor.

8. The pixel circuit according to claim 1, wherein the data writing circuit comprises a first switching transistor, and
a gate electrode of the first switching transistor is connected to the first control signal terminal, a first electrode of the first switching transistor is connected to the data signal terminal, and a second electrode of the first switching transistor is connected to the first node.

9. The pixel circuit according to claim 1, wherein the compensation control circuit comprises a second switching transistor, and
a gate electrode of the second switching transistor is connected to the second control signal terminal, a first electrode of the second switching transistor is connected to the control terminal of the drive circuit, and a second electrode of the second switching transistor is connected to the first terminal of the drive circuit.

10. The pixel circuit according to claim 1, wherein the light-emitting control circuit comprises a third switching transistor, and
a gate electrode of the third switching transistor is connected to the light-emitting control signal terminal, a first electrode of the third switching transistor is connected to the first power terminal, and a second electrode of the third switching transistor is connected to the first terminal of the drive circuit.

11. The pixel circuit according to claim 4, wherein the driving transistors are N-type transistors.

12. The pixel circuit according to claim 8, wherein the first switching transistor is a P-type transistor or an N-type transistor.

13. A display panel, comprising a plurality of pixel units arranged in an array, wherein each of the pixel units comprises the pixel circuit according to claim 1.

14. A display device, comprising the display panel according to claim 13.

15. The display device according to claim 14, further comprising: a plurality of first control signal lines, a plurality of second control signal lines, a plurality of light-emitting control signal lines, and a plurality of data signal lines,
wherein a first control signal line in each row is connected to the first control signal terminals of pixel circuits in the row;
a second control signal line in each row is connected to the second control signal terminals of pixel circuits in the row;
a light-emitting control signal line in each row is connected to the light-emitting control signal terminals of pixel circuits in the row; and
a data signal line in each column is connected to the data signal terminals of pixel circuits in the column.

16. A driving method of the pixel circuit according to claim 1, comprising: a reset and compensation phase, a data writing phase and a light-emitting phase,
wherein in the reset and compensation phase, the compensation control circuit enables the control terminal of the drive circuit to be electrically connected to the first terminal of the drive circuit under control of the second control signal terminal;
in the data writing phase, the data writing circuit provides the signal of the data signal terminal to the first node under control of the first control signal terminal; and
in the light-emitting phase, the storage circuit maintains the voltage difference between the first node and the control terminal of the drive circuit, and maintains the voltage difference between the first node and the second terminal of the drive circuit, and the light-emitting control circuit provides the signal of the first power terminal to the drive circuit under control of the light-emitting control signal terminal, and the drive circuit outputs the driving current.

17. The pixel circuit according to claim 9, wherein the second switching transistor is a P-type transistor or an N-type transistor.

18. The pixel circuit according to claim 10, wherein the third switching transistor is a P-type transistor or an N-type transistor.
